(19) United States
(12) Patent Application Publication
(10) Pub. No.: US 2015/0147159 A1
(43) Pub. Date: May 28, 2015

(54) HOUSING ARRANGEMENT FOR A GAS TURBINE

(71) Applicant: Rolls-Royce Deutschland Ltd & Co KG, Blankenfelde-Mahlow (DE)

(72) Inventor: Christian HOMEYER, Berlin (DE)

(21) Appl. No.: 14/548,883

(22) Filed: Nov. 20, 2014

(30) Foreign Application Priority Data
Nov. 21, 2013 (DE) 10 2013 223 827.4

(51) Int. Cl. F01D 21/00; F01D 25/28; F01D 25/26

(52) U.S. Cl. CPC F01D 21/003; F01D 25/26; F01D 25/28; F05D 2220/32; F05D 2230/60
USPC 415/118; 29/889.2

(57) ABSTRACT

A casing arrangement of a gas turbine includes a sensor element of elongated design that when seen in the longitudinal direction has a front end and a rear end, a first casing structure, a second casing structure arranged at a distance from the first casing structure and having a receptacle for the front end of the sensor element, and a guide structure having an elongated guide opening for the sensor element. The sensor element extends between the first casing structure and the second casing structure, while being arranged along a section in the elongated guide opening of the guide structure, where the sensor element due to the elongated guide opening is aligned and positioned such that its front end is located, and can only be located, inside the receptacle of the second casing structure.

### CROSS-REFERENCE TO RELATED APPLICATION

This application claims priority to German Patent Application No. 10 2013 223 827.4 filed on Nov. 21, 2013, the entirety of which is incorporated by reference herein.

### BACKGROUND

This invention relates to a casing arrangement of a gas turbine. In particular, the invention relates to a casing arrangement of a jet engine into which a sensor element is installed in a clearly defined position.

An aircraft engine includes a compressor, a combustion chamber and a turbine. Compressor and turbine are connected here to one another via a shaft. This shaft is mounted in a so-called bearing chamber with bearing elements that are lubricated and cooled with oil.

Oil leaks out of the bearing chambers must be avoided here, as a leak of this type at hot engine elements, in particular at turbine elements, can lead to oil fires. Even if the bearing chambers are subjected to compressed air from the outside to prevent any unwelcome oil leakage, there is still a residual risk of leakage occurring. In this case, it is important to detect any oil fire caused by oil leaking out of the bearing chamber at an early stage. This is achieved using one or more temperature sensors, also referred to as “TURBOTs” (TURBOT=TURBine Over Temperature). Temperature sensors of this type detect a temperature increase in the event of an oil fire, so that a cockpit warning for the pilot can be given by an engine control unit.

Temperature sensors of this type are as a rule designed rod-like and, in a current application in the TP400 engine of the Airbus A400M, have a diameter of approx. 4 mm and a length of approx. 130 mm. A temperature sensor is inserted during installation from the outside into the turbine casing (also referred to as “hot strut”) in such a way that it is fitted, through an outer casing structure and a circumferential annular chamber, into a sensor receptacle of an inner casing structure, so that it can measure the temperature at a defined point in the area of the inner casing structure at which the temperature rises in the event of an oil fire.

Installation in this manner is however disadvantageous in that there is a risk of incorrect placing of the sensor, i.e. the sensor is not placed in the required sensor receptacle of the inner engine casing, but for example has its end off-centre from the receptacle, and so measures the temperature at a wrong place. Since the end of the sensor is arranged inside the inner engine casing, there is no possibility of the correct placing being checked visually by the fitter, so that correct installation can only be verified in a complex test, where a mini-camera (a so-called borescope unit) is inserted into the casing.

The stated problem of verifying the correct positioning of a sensor inside a casing is also faced in other situations in which a casing has several structures spaced from one another.

### SUMMARY

An object underlying the present invention is to provide a casing arrangement for a gas turbine, that allows the installation of a sensor in the casing arrangement in an always clearly defined position.

It is a particular object of the present invention to provide solution to the above problems by a casing arrangement having the features as described herein and a method for installing a sensor element of elongated design in a casing arrangement having the features as described herein.

Accordingly, the solution in accordance with the invention provides that a sensor element of elongated design, which has a front end and a rear end when seen in the longitudinal direction, extends between a first casing structure and a second casing structure. The sensor element passes here along a section in an elongated guide opening formed in a guide structure. Due to the elongated guide opening, the sensor element is aligned and positioned such that its front end is located, and can only be located, inside a receptacle of the second casing structure provided for that purpose.

The solution in accordance with the invention thus enables the installation of a sensor element in a casing arrangement in a defined position in that it provides inside a guide structure an elongated guide opening which automatically aligns and positions the sensor element such that the front end of the latter is necessarily located in the receptacle of the second casing structure and is hence installed in the correct position.

An advantageous embodiment of the invention provides that the guide structure is formed by a guide plate, which is for example connected to or integrated into the first casing structure, for example in a hole or opening of the first casing structure. This permits a particularly simple installation, since the fitter can insert the sensor element into the guide plate in the area of the first casing structure which is facing the fitter. Alternatively, it can be provided that the guide structure is formed by a structural component of the first casing structure. To that end, it can for example be provided that the guide structure is formed by a casting of the first casing structure and that a guide opening is provided inside said casting.

A further embodiment of the present invention provides that the rear end of the sensor element is defined, i.e. is spatially fixed in the area of the first casing structure. To do so, it can for example be provided that the rear end of the sensor element is fixed in a mounting plate, said mounting plate being fastened to the first casing structure and/or to the guide structure. It can be provided here that the mounting plate forms part of the sensor element, which in this case consists of an elongated sensor element and the mounting plate. It can furthermore be provided that the rear end of the sensor element projects some way out of the actual mounting plate to permit simple handling of the sensor element.

A further embodiment of the invention provides that the elongated guide opening for the sensor element is designed as a longitudinal hole in the guide plate. Alternatively, it is however just as conceivable that the elongated guide opening is for example formed by part-elements of the guide plate which combine with one another to form the elongated guide opening.

It is generally pointed out here that the longer the elongated guide opening of the guide structure is designed, the more precise are the alignment and positioning of the sensor element. It is also the case that the smaller the clearance of the sensor element inside the elongated guide opening is, the more precise are the alignment and positioning of the sensor element. It is preferably provided here that the sensor element is arranged in the elongated guide opening of the guide structure with a certain clearance to permit easy insertion and removal of the sensor element into/out of the elongated guide opening. The greater the clearance is here, the greater is the longitudinal extent of the elongated guide opening that needs to be selected for overall achievement of the required exact positioning and alignment of the sensor element.

Depending on the distance between the first casing structure and the second casing structure, on the diameter of the sensor element, on the length of the elongated guide opening in the guide structure and on the clearance with which the sensor element is arranged inside the elongated guide opening of the guide structure, the length of the elongated guide opening in the guide structure is for example between 3% and 20% of the overall length of the sensor element. The elongated guide opening in the guide structure can however also be designed longer or shorter.

In accordance with a further embodiment of the invention, the first engine structure is formed by an outer engine casing and the second engine structure by an inner engine casing, where said inner engine casing is arranged radially on the inside relative to the outer engine casing. The inner engine casing and the outer engine casing are thus at a distance from one another in the radial direction, and it is provided that a flow duct in the form of an annular chamber is formed between the inner engine casing and the outer engine casing. The outer engine casing and the inner engine casing are for example components of a turbine casing.

It is provided here in accordance with an embodiment of the invention that the sensor element extending between the outer engine casing and the inner engine casing, runs in the flow duct inside a strut that connects the outer engine casing and the inner engine casing to one another. These struts act as structural components of the turbine casing.

It is pointed out that the elongated guide opening for the sensor element provided in the guide structure can, generally speaking, have any spatial orientation. The spatial orientation depends on the point of the second casing structure at which the receptacle for the front end of the sensor element is located. For example, the elongated guide opening in the guide structure can extend in the radial direction or obliquely to the radial direction.

In accordance with an exemplary embodiment, the sensor element has a length between 50 mm and 200 mm and a width between 2 mm and 10 mm, in particular a length between 110 mm and 150 mm and a width between 3 mm and 5 mm.

The sensor element of elongated design is, in accordance with an embodiment of the present invention, designed as a temperature sensor intended to measure a temperature prevailing in the area of its front end. Generally speaking, however, the sensor element can also be designed to measure another relevant engine parameter or several such parameters. For example, the sensor element can alternatively measure a pressure or a speed.

The present invention also relates to a method for installing a sensor element of elongated design in a casing arrangement. The method includes the following steps:
provision of a casing arrangement having: a first casing structure, a second casing structure arranged at a distance to the first casing structure and having a receptacle for a sensor element, and a guide structure having an elongated guide opening for the sensor element,
provision of a sensor element of elongated design, which has a front end and a rear end when seen in the longitudinal direction, and
insertion of the sensor element into the elongated guide opening of the guide structure and longitudinal displacement of the sensor element in the elongated guide opening, said sensor element in the elongated guide opening receiving a spatial alignment such that the front end of the sensor element is displaced in the direction of the receptacle of the second casing structure and positioned inside the latter.

### BRIEF DESCRIPTION OF THE DRAWINGS

The present invention is described in more detail in the following with reference to the figure of the accompanying drawing, showing an exemplary embodiment.

FIG. 1 shows an exemplary embodiment of a casing arrangement of a jet engine including an outer engine casing, an inner engine casing and a temperature sensor.

### DETAILED DESCRIPTION

The invention is described in the following by way of example, using a casing arrangement in the turbine area of a jet engine. The principles of the present invention apply however in the same way for other gas turbines.

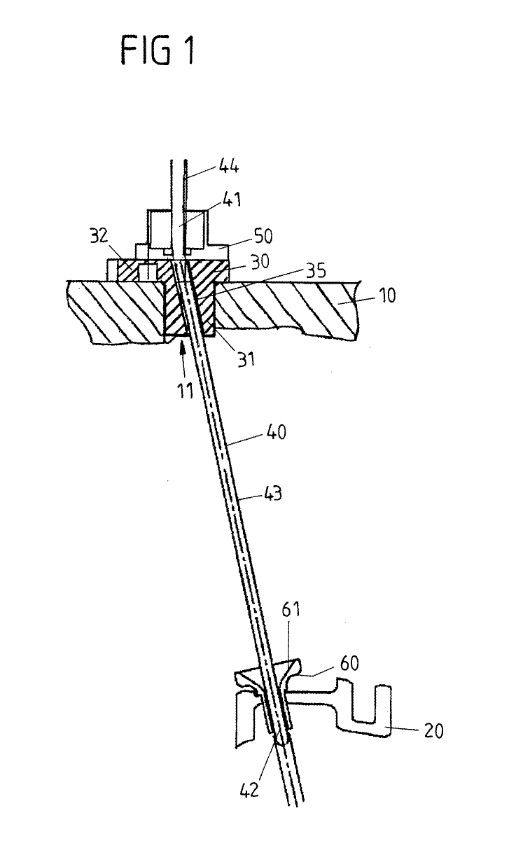

FIG. 1 shows an engine casing arrangement having an outer engine casing 10 and an inner engine casing 20 arranged radially at a distance therefrom, where the inner engine casing 20 is arranged radially on the inside relative to the outer engine casing 10. A flow duct designed as an annular duct (not shown separately) runs between the two engine casings. The outer engine casing 10 and the inner engine casing 20 are here connected to one another using struts (not shown separately) which act as structural components of the turbine casing.

The casing arrangement furthermore includes an elongated sensor element 40, in particular of rod-like design, which when seen in the longitudinal direction has a front end 42, a rear end 41 and between these a central area 43.

Furthermore, a guide plate 30 is provided which is connected to the outer engine casing 10. To do so, it is provided in the exemplary embodiment shown that the outer engine casing 10 has an opening 11 in which extends a radially extending section 31 of the guide plate 30. A further section 32 of the guide plate contacts the radially outer side of the outer casing structure 10.

Furthermore, the guide plate 30 includes an elongated guide opening 35 in the form of a straight-line longitudinal hole passing right through the guide plate 30 in a substantially radial direction. The longitudinal hole 35 has a defined orientation which depends on the location of a receptacle 60 in the second casing structure 20 (see below) and has a defined diameter.

It is provided here that the longitudinal hole 35 has a circular cross-section. Depending on the shaping of the sensor element 40, however, a cross-sectional shape diverging from that, for example a rectangular cross-sectional shape, can also be provided.

As part of the overall temperature sensor, the upper end 41 of the sensor element 40 is fastened in a mounting plate 50 arranged on the guide plate 30. Alternatively, the mounting plate 50 can be arranged on the outer casing structure 10 instead of on the guide plate 30, if said guide plate 30 is designed as a structural part of the outer casing structure 10 and hence its functionality is assured by the outer casing structure 10.

In the area of the inner engine casing 20, a receptacle 60 having a funnel-shaped opening orifice 61 is provided. The receptacle 60 is in rigid structural connection with the inner engine casing 20. It can for example be arranged in a recess or hole of the inner engine casing 20. Diverging from that, the receptacle 60 with the funnel-shaped opening orifice 61 can also be a structural part of the engine casing 20.

During assembly, the elongated sensor element 40 is passed from the outside through the elongated guide opening 35 of the guide plate 30 in the direction of the inner engine casing. Here, the guide opening 35 positions the sensor element 40 such that during fitting the front end 42 of the sensor element 40 is necessarily inserted into the opening orifice 61 of the receptacle 60 and positioned in the receptacle 60 at the required location. As a result, incorrect installation is reliably prevented.

As part of the entire temperature sensor, the rear end 41 of the sensor element 40 is fastened in the mounting plate 50. It can be provided here that the rear end 41 of the sensor element is angled relative to the central area 43 and to the front end 42 of the sensor element 40. It can also be provided that an area 44 of the sensor element 40, which is for example formed by a metal sleeve and is used for routing electrical cables (not shown) projects out of the mounting plate 50. The actual temperature measurement is done in the area of the front end 42 of the sensor element 40.

The sensor element 40 runs in its central area 43 that extends between the outer engine casing 10 and the inner engine casing 20, inside a strut not shown, which as a structural element extends radially inside the flow duct between the inner and the outer engine casings. In the figure shown, such a strut is not represented separately for clarity reasons.

Providing an elongated guide opening in a guide plate which is arranged in an opening or recess of the outer engine casing enables a defined spatial orientation of the sensor element 40 to be provided, such that the front end 42 of the sensor element 40 moves during the assembly process exactly in the direction of the receptacle 60 and is securely received therein.

The sensor element 30 can be arranged here, for the purposes of simple assembly, with a low clearance inside the guide opening 35, said clearance however being low enough to ensure that the front end 42 of the sensor element can be securely inserted in the area of the conically shaped insertion orifice 61 of the receptacle 60.

The solution in accordance with the invention thus permits the arrangement of a sensor element of elongated design inside a casing arrangement with casing structures arranged at a distance from one another such that a defined spatial position of the sensor element is obtained and secured, so that complex checking of the position using mini-cameras can be dispensed with.

The present invention, in its design, is not limited to the above exemplary embodiment, which is only to be understood as an example. For instance, the guide plate can have a different shape to that shown and/or be a structural part of the engine casing and/or form an elongated guide opening in another way.

1. A casing arrangement of a gas turbine comprising:
a sensor element of elongated design that when seen in the longitudinal direction has a front end and a rear end,
a first casing structure,
a second casing structure arranged at a distance from the first casing structure and having a receptacle for the front end of the sensor element, and
a guide structure having an elongated guide opening for the sensor element,
where the sensor element extends between the first casing structure and the second casing structure, while being arranged along a section in the elongated guide opening of the guide structure, where the sensor element due to the elongated guide opening is aligned and positioned such that its front end is located, and can only be located, inside the receptacle of the second casing structure.

2. The arrangement in accordance with claim 1, wherein the guide structure is formed by a guide plate, which is connected to or integrated into the first casing structure.

3. The arrangement in accordance with claim 2, wherein the guide plate is arranged in a hole or opening of the first casing structure.

4. The arrangement in accordance with claim 1, wherein the guide structure is formed by a structural component of the first casing structure.

5. The arrangement in accordance with claim 1, wherein the rear end of the sensor element is defined in the area of the first casing structure.

6. The arrangement in accordance with claim 5, wherein the rear end of the sensor element is fixed in a mounting plate, said mounting plate being fastened to the guide structure and/or to the first casing structure.

7. The arrangement in accordance with claim 6, wherein the mounting plate forms part of the sensor element, where the rear end of the sensor element is fastened in the mounting plate.

8. The arrangement in accordance with claim 1, wherein the elongated guide opening for the sensor element is designed as a longitudinal hole in the guide plate.

9. The arrangement in accordance with claim 1, wherein the sensor element is arranged in the elongated guide opening with a certain clearance.

10. The arrangement in accordance with claim 1, wherein the length of the elongated guide opening in the guide structure is for example between 3% and 20% of the length of the sensor element.

11. The arrangement in accordance with claim 1, wherein the first engine structure is an outer engine casing and the second engine structure is an inner engine casing, where said inner engine casing is arranged radially on the inside relative to the outer engine casing.

12. The arrangement in accordance with the claim 11, wherein the outer engine casing and the inner engine casing form a flow duct between them.

13. The arrangement in accordance with the claim 12, wherein the sensor element in the flow duct runs inside a strut that connects the outer engine casing and the inner engine casing to one another.

14. The arrangement in accordance with claim 1, wherein the elongated guide opening for the sensor element in the guide structure extends obliquely to the radial direction of the engine casing arrangement.

15. The arrangement in accordance with claim 1, wherein the outer engine casing and the inner engine casing are components of a turbine casing.

16. The arrangement in accordance with claim 1, wherein the sensor element has a length between 50 mm and 200 mm and a width between 2 mm and 10 mm, in particular a length between 110 mm and 150 mm and a width between 3 mm and 5 mm.

17. The arrangement in accordance with claim 1, wherein the sensor element is a temperature sensor.

18. The arrangement in accordance with claim 1, wherein the receptacle for the front end of the sensor element has a conically shaped insertion orifice.

19. A method for installing a sensor element of elongated design in a casing arrangement, comprising the following steps:
provision of a casing arrangement having comprising:
a first casing structure,
a second casing structure arranged at a distance from the first casing structure and having a receptacle for a sensor element, and
a guide structure having an elongated guide opening for the sensor element,
provision of a sensor element of elongated design, that when seen in the longitudinal direction has a front end and a rear end,
insertion of the sensor element into the elongated guide opening of the guide structure and longitudinal displacement of the sensor element in the elongated guide opening, said sensor element in the elongated guide opening receiving a spatial alignment such that the front end of the sensor element is displaced in the direction of the receptacle of the second casing structure and positioned inside the latter.
